(19) United States
(12) Patent Application Publication
(10) Pub. No.: US 2026/0203492 A1
(43) Pub. Date: Jul. 16, 2026

(54) EXTENDING MACHINE LEARNING MODEL REVISION CAPABILITIES TO LONG FORM CONTENT

(71) Applicant: Composable Prompts Corp, New York, NY (US)

(72) Inventor: Eric Barroca, Tokyo-to (JP)

(21) Appl. No.: 19/018,382

(22) Filed: Jan. 13, 2025

(51) Int. Cl. G06F 40/166; G06F 40/40

(52) U.S. Cl. CPC G06F 40/166; G06F 40/40

(57) ABSTRACT

Methods, systems, and apparatus, including computer programs encoded on a computer storage medium, for generating long form content using large language models. Methods include obtaining a textual electronic document. Reference points are inserted at different locations within the textual electronic document to generate a referenced document. An input describing a set of proposed modifications to the textual electronic document is created. The input is submitted to the one or more LLMs. A response that includes, for each given proposed modification in the set of proposed modifications, (i) a corresponding action required to achieve the given proposed modification and (ii) one or more of the reference points specifying where the corresponding action is required to be performed to achieve the given proposed modification. Content of the textual electronic document is transformed to a revised document based on the response. The revised document is output to a client device.

### BACKGROUND

This specification relates to processing data, and using machine learning models to perform tasks. More specifically, this specification provides solutions for extending the revision capabilities of machine learning models to long form content.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can transform a textual electronic document into a revised document including situations in which the size of the textual electronic document exceeds an output window of available machine learning models. In this specification, a textual electronic document refers to an electronic document including data that causes presentation of a set of textual content at a client device. An electronic document (which for brevity can be simply referred to as a document) does not necessarily correspond to a file. That is, a document may be stored in a portion of a file that holds other documents, in a single file dedicated to the document in question, or in multiple coordinated files. For brevity, the phrase “text document” is also used to refer to a textual electronic document.

In particular, the system is connected between a client device and one or more external large language models (LLMs) that are each configured to process prompts, e.g., directive instructions, and are associated with an output size limit. In some cases, the prompts relate to modification of an input document, such as revising an existing document. More specifically, the system can be implemented to use one or more LLMs to perform modifications of documents that are larger than a maximum output window of the one or more LLMs, which prevents the one or more LLMs from being able to perform the requested modifications of the documents. In this way, the proposed system can overcome the limitations of LLMs, while still utilizing the powerful analytical capabilities of the LLMs to analyze the text document being modified.

For example, the system can receive a request to modify an existing text document, generate a prompt describing the modifications to the document that are being requested, and submit a referenced version of the text document that includes reference points inserted by the system to one or more LLMs along with the prompt. The one or more LLMs analyze the referenced version of the text document according to the prompt, and respond to the system with a set of actions that need to be performed to modify the text document in the manner specified, and using the reference points to specify the locations of the text document at which the set of actions need to be performed. The system can use the response from the one or more of the LLMs to make the specified changes at the specified locations of the text document to create a revised document. Particular embodiments of the subject matter described in this specification can be implemented so as to realize one or more advantages.

The system of this specification provides for using one or more LLMs to perform the transformation of a textual electronic document into a revised electronic document (e.g., modified as requested by a requesting entity, such as a user and/or client device) even when the size of the document being modified is larger than the output window(s) of the one or more LLMs. As used herein, the output window of an LLM refers to the maximum number of tokens (e.g., units of text such as a word or portion of a word) that an LLM can generate in a single response. Currently, most available LLMs have an output window in the range of 4,000 tokens (e.g., words), and a response to a query will not exceed the output window. That is, the LLM will stop generating a response (or generate an error) when the output window is reached, and the response may be sent even if the output is not a complete response. Moreover, when an LLM is requested to modify a text document, the LLM generally generates an entire new version of the text document including the revisions. Therefore, when the size of (e.g. number of tokens in) the document being analyzed and revised exceeds to the output window (e.g., maximum token output limit) of the LLM, the LLM will not be able to generate the revised document in full, such that the LLM cannot be used to perform the desired document revisions.

To overcome these shortcomings, solutions are presented that reduce the output tokens required to be generated by the LLM in the context of revising an oversized document (e.g., a text document having a higher token count than the output window of the LLM), thereby enabling modification/revision of documents that are much larger than the output window of the LLMs. For example, rather than requesting the LLM to perform the revisions to the text document, the system instructs the LLM to analyze the text document and return a set of actions required to be performed to achieve proposed modifications to the document. For example, assume that a document includes a limited liability clause, and the proposed modifications to the document are to (i) remove the limited liability clause, (ii) remove references to the limited liability clause, and (iii) correct spelling and/or grammatical errors in the document. Further assume for purposes of this example, that the document includes 10,000 tokens, and that the output window for the LLM is 4,000 tokens. Since the LLM itself cannot generate an output of more than 4,000 tokens, the LLM is incapable of generating a revised version of the document. However, the LLM can be instructed, e.g., by way of one or more prompts, to analyze the document to identify the limited liability clause, references to the limited liability clause, and spelling/grammatical errors in the document, and generate a response specifying actions required to be performed in order to remove the limited liability clause, remove references to the limited liability clause, and correct spelling/grammatical errors in the document. As such, the present system is configured to generate a prompt that instructs the LLM to generate a set of actions required to realize a set of proposed modifications to a text document, which can then be carried out by way of simple operations, such as a delete operation, insert operation, and/or rewrite operation, rather than recreating the entirety text document in a revised form.

Although the LLM can generate a set of actions required to realize a set of proposed modifications, the LLM is generally incapable of specifying the locations within the document at which the set of actions need to be performed because documents input to the LLMs generally lack sufficient reference points that the LLM can use for purposes of precisely specifying the action locations. The solutions presented herein overcome this shortcoming by inserting reference points into content of the text document to create a referenced document (e.g., a version of the text document that includes the reference points). In some implementations, the reference points are line numbers that are inserted into the text document by the system, but other reference points can be used (e.g., sentence numbers, paragraph numbers, etc.). The system can input the referenced document to the LLM with the prompt, and instruct the LLM to use the reference points to specify the locations at which the actions required to achieve the proposed modifications need to be performed. For example, if the limited liability clause to be removed spans lines 8000-8200 (e.g., starts at line 8000 and ends at line 8200) of the referenced document, the response from the LLM can specify that the text of the sentences from lines 8000-8200 need to be deleted to remove the limited liability clause. As such, the proposed solution overcomes existing shortcomings of using LLMs to perform document revisions, thereby improving the capabilities of LLMs.

Furthermore, by only requiring the LLM to generate a list of actions to be performed, and identifying the locations at which the actions are to be performed, the number of tokens required to be generated by the LLM to perform the document revisions is reduced relative to conventional LLM systems in which the LLM regenerates an entirely new version of the document being revised. This reduction in the number of tokens generated by the LLM reduces the computational requirements of using the LLM to revise a document relative to conventional techniques LLM systems.

A technical problem overcome by the solutions presented in this specification is the problem of how to effectively and accurately use machine learning models to evaluate, analyze, or otherwise revise documents that are larger (e.g., have more tokens) than the machine learning models are capable of generating in a single output. This problem is solved, for example, by only requiring the machine learning models to generate a response specifying actions that need to be made to the document to achieve the desired modifications, and locations of the documents (e.g., by way of reference points) at which the changes need to be made. This enables the machine learning models to generate smaller outputs, which are within the size limits of the machine learning models and still be used for evaluation of the document. In this way, the amount of data (e.g., number of tokens) needed to be generated and output by the machine learning models is reduced relative to outputting the entire revised document by the machine learning models. This also reduces the latency of obtaining outputs from the machine learning models. In at least these ways, the presently described and claimed solutions improve the functioning of a machine learning system itself.

According to an aspect there is provided a method for modifying a document that is larger than the output window of one or more LLMs. The methods can include operations including obtaining, by a system that is connected between a client device and one or more large language models (LLMs), a textual electronic document; inserting, by the system, reference points at different locations within the textual electronic document to generate a referenced document that includes the reference points; creating, by the system, an input describing a set of proposed modifications to the textual electronic document, wherein the prompt includes instructions that cause the one or more LLMs to generate a response that includes, for each given proposed modification in the set of proposed modifications, (i) a corresponding action required to achieve the given proposed modification and (ii) one or more of the reference points specifying one or more locations of the referenced document at which the corresponding action is required to be performed to achieve the given proposed modification; submitting, by the system, the input to the one or more LLMs; receiving, by the system and from the one or more LLMs, the response that includes, for each given proposed modification in the set of proposed modifications, (i) the corresponding action required to achieve the given proposed modification and (ii) the one or more of the reference points specifying one or more locations of the referenced electronic document at which the corresponding action is required to be performed to achieve the given proposed modification; transforming, by the system, content of the textual electronic document into a revised document by performing, for each given proposed modification in the set of proposed modifications, the corresponding action, required to achieve the proposed modification, at the one or more locations specified by the one or more reference points; and outputting, by the system, the revised document to a client device. Other embodiments of this aspect include corresponding systems, apparatus, and computer programs, configured to perform the actions of the methods, encoded on computer storage devices.

These and other embodiments can each optionally include one or more of the following features. Methods can include receiving, by the system and from the client device, a request specifying one or more changes to be made to the textual electronic document. Creating the input describing a set of proposed modifications to the textual electronic document by the one or more LLMs can include generating the input based on the changes specified by the request. Creating the input can include generating instructions that cause the one or more LLMs to specify, as the corresponding action for a given proposed modification, one of an insert operation, delete operation, or rewrite operation required to achieve the given proposed modification.

Methods can include receiving, as input from the client device, an interaction definition specifying (i) an interaction name of the interaction, (ii) an interaction description of the interaction, (iii) prompt segments, (iv) a schema, and (v) a configuration. The interaction can define a set of tasks the one or more LLMs are being requested to perform. The interaction name can uniquely identify the interaction from other interactions. The interaction description can provide a description of the interaction. The prompt segments can provide a list of prompt templates that are rendered as part of the prompt. The schema can specify a structured format for the response. The configuration can specify, for each of the one or more LLMs, an environment that connects to an inference provider of the LLM, a model to execute the interaction, and execution parameters.

The textual electronic document can have a token size that exceeds a maximum output window of the one or more LLMs that prevents the one or more LLMs from creating the revised document resulting from performing, for each given proposed modification in the set of proposed modifications, the corresponding action at the one or more locations specified by the one or more of the reference points.

Inserting the reference points can include inserting line numbers into the content of the textual electronic document. Transforming the referenced document into a revised document can include transforming the referenced document into a revised document by performing, for each given proposed modification in the set of proposed modifications, the corresponding action at the one or more locations specified by the one or more of the line numbers.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a system diagram of an example LLM management system that connects a client device and one or more external LLMs.

FIG. 2 is an illustration of an example data flow for modifying a document.

FIG. 3 is a flow chart of an example process for utilizing a LLM to modify a document.

FIG. 4 illustrates an example of a computing device and a mobile computing device that can be used to implement the techniques described here.

Like reference numbers and designations in the various drawings indicate like elements.

### DETAILED DESCRIPTION

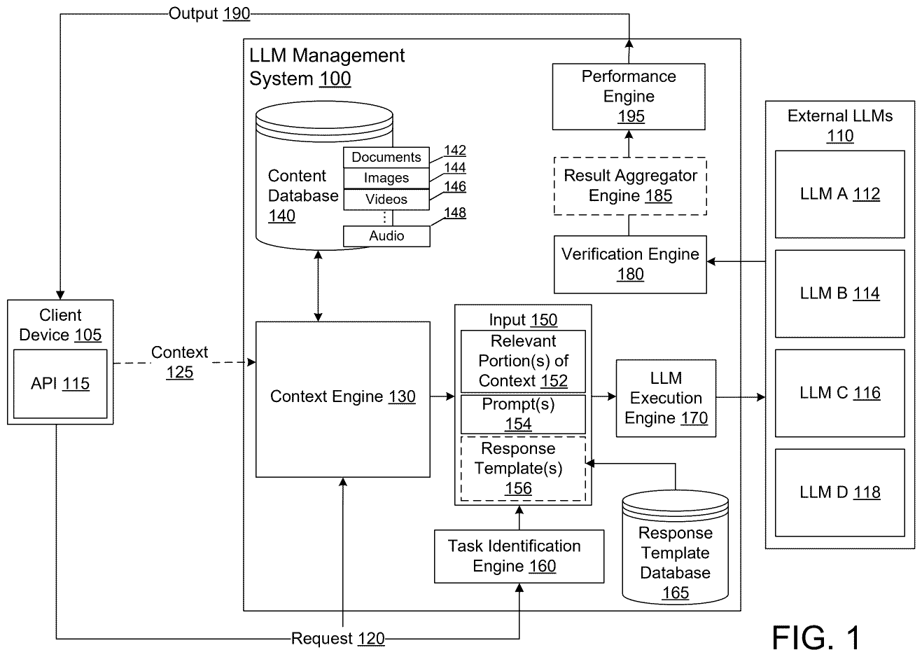

FIG. 1 shows an example LLM management system 100. The LLM management system 100 is an example of a computer implemented system. The LLM management system can be implemented as computer programs on one or more computers in one or more locations in which the systems, components, and techniques described throughout this specification are implemented.

The LLM management system 100 can be connected between a client device 105 and one or more external large language models (LLMs) 110. In particular, the system 100 can receive a request 120 from the client device 105, can determine an execution strategy for the request 120, and can provide for the configuration of an input 150 to at least one of the one or more LLMs 110 based on the execution strategy for the request 120, e.g., using at least one of the one or more external LLMs 110.

Each LLM in the external LLMs 110, e.g., LLM A 112, LLM B 114, LLM C 116, and LLM D 118, can have a recurrent neural network architecture that is configured to sequentially process the contents of an input, e.g., a prompt, and trained to perform next element prediction, e.g., to define a likelihood score distribution over a set of next elements. More specifically, each LLM can be a transformer-based, e.g., an encoder-decoder transformer, an encoder-only transformer, or a decoder-only transformer, model that is configured to perform parallel processing of the contents of the multimodal input using a multi-headed attention mechanism. In particular, each large language model can be configured to process a sequence of input tokens and to predict a sequence of output tokens using a likelihood score distribution over a set of next elements based on the previously predicted output tokens.

In particular, the external LLMs 110 can be implemented with the same neural network architecture or with different neural network architectures. For example, LLM A 112 and LLM B 114 can be implemented with a first architecture, e.g., a Generative Pretrained Transformer (GPT) architecture, LLM C 112 can be implemented with a second architecture, e.g., a Text-to-Text Transfer Transformer (T5) architecture, and LLM D 118 can be implemented with a third architecture, e.g., a Bidirectional Encoder Representations from Transformer (BERT). As another example, a subset of the LLMs in the external LLMs 110 can have been finetuned from a foundational model for particular tasks in a mixture-of-experts model.

In some cases, one or more of the external LLMs 110 are multi-modal LLMs, e.g., that are configured to process one or more of a text modality, an image modality, an audio modality, or a video modality. For example, the external LLMs 110 can include a vision transformer, a contrastive language-image pretraining (CLIP) model, or a DALL-E model.

More specifically, the system 100 can configure an input 150 to one or more of the external LLMs using the request 120. In particular, the system 100 can determine an execution strategy to execute the request 120 using the external LLMs 110. More specifically, the system 100 can determine one or more prompts 154 from the request 120, provide for the design of response templates 156 as example output formatting for the LLMs 110, and extract relevant data from any context 125 provided with the request 120. The system 100 can then route the input 150 to one or more of the external LLMs.

For example, the system 100 can receive a request 120 and, in some cases, a context 125 from the client device 105, e.g., by way of an applied programming interface (API) 115, for processing using an LLM. For example, the API 115 can enable a user, e.g., the user of the client device 105, to input requests and content to the system as context 125 for the request 120. As an example, the API 115 can be provided to the user over a network, e.g., the internet.

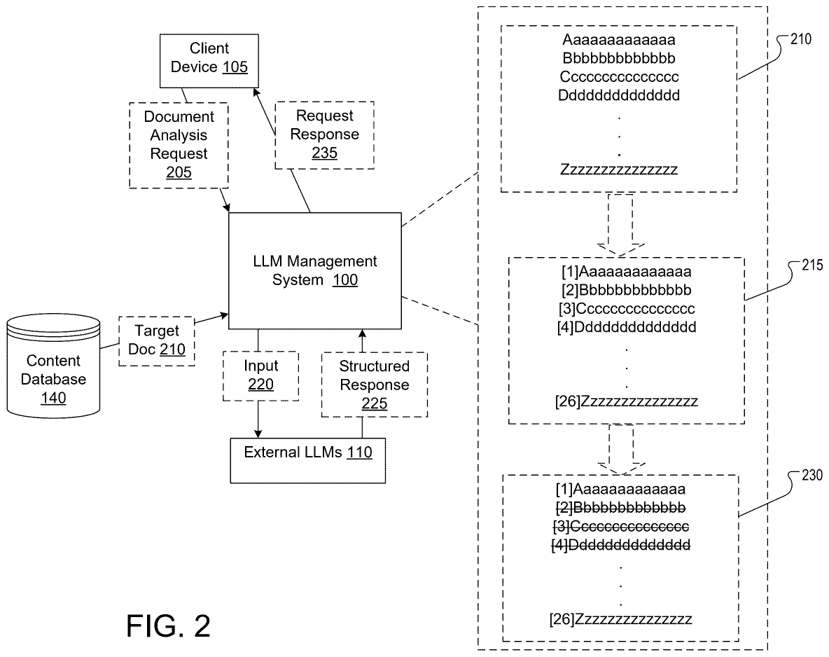

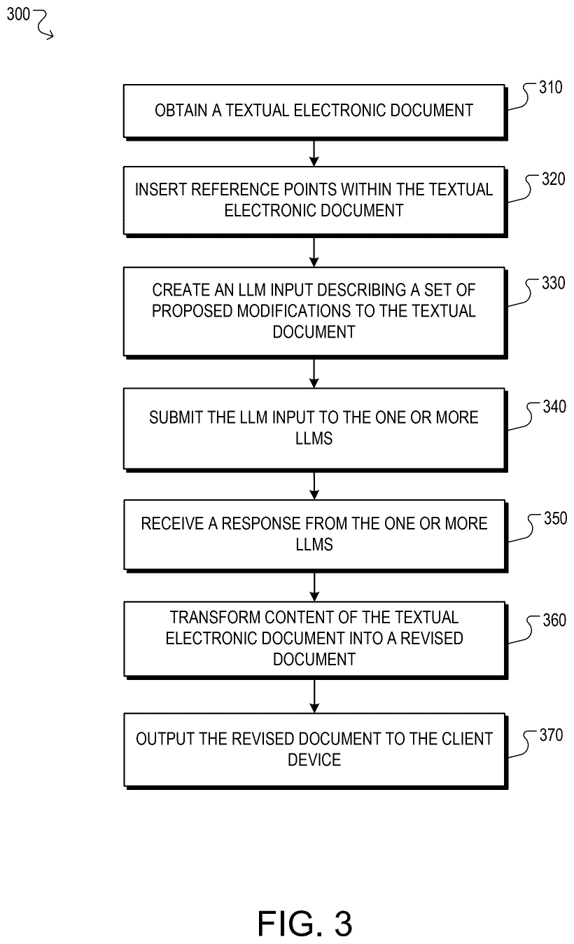

In the case that the system receives a context 125, the context 125 can be, e.g., a text, a book, a legal document, a webpage, etc. As another example, the context 125 can be an image input, an audio input, or a video input. In this case, the request 120 can include a directed instruction that relates to the context 125. As an example, the request 120 can include a direction to identify “What are the themes of this media?” for an image or video context, or a list of corresponding text analysis questions for a textual electronic document, e.g., a legal contract. In some implementations, the request 120 can be a request to modify a text document, as discussed in more detail below with reference to FIGS. 2 and 3.

The system 100 can process the context 125 using a context engine 130. In particular, the system 100 can process the context 125 to extract relevant associated data from the context 125, e.g., metadata that can facilitate the use of the context 125 in the input 150 to the LLMs 100. Additionally, the engine 130 can generate a context identifier for the context 125, e.g., to facilitate the identification of the context 125 in a data storage location.

In the particular example depicted, the system 100 can then maintain the context 125 and associated data in a content database 140. As an example, the content database 140 can include structured data, e.g., tables, that correspond with different context types, e.g., a documents table 142, an images table 144, a videos table 146, an audio table 148, etc.

For example, each table in the database 140 can be indexed using the context identifier generated by the context engine 130. In particular, in response to a request 120 that pertains to the context 125, e.g., that does not include the context 125 or includes a previously processed context 125, the system 100 can use the context identifier to identify the context 125 from the database 140. The system 100 can then include the context 125 or one or more relevant portions of the context 125 in the input 150 to the LLMs 110. In some implementations, the system 100 can maintain a textual electronic document in the content database 140, e.g., for use as the relevant portion(s) of context 152 in the input 150. For example, as discussed in more detail below, the textual electronic document can be the target for a set of proposed modifications specified in, and/or derived from, instructions the request 120. In this example, when the request 120 is received, the context engine 130 can use information in the request 120 to identify the electronic text document as the targe for the set of proposed modifications, obtain the electronic text document from the content database 140, and include the electronic text document in the input as, at least part of, the relevant portion(s) of the context 152.

In addition to the relevant portion(s) of the context 152, the input 150 can be generated to include one or more prompt(s) 154 corresponding with the request 120. In particular, the system 100 can process the request 120 to determine one or more prompts 154, e.g., directive instructions to complete a particular task corresponding with the request 120, using a task identification engine 160. In this case, each task identified by the engine 160 can be included in a separate prompt. As an example, the task identification engine 160 can process the request 120, determine one or more tasks from the request 120, and generate one or more prompts 154 corresponding with the request. As another example, the engine 160 can process the request 120, decompose the request 120 into a set of sub-requests, and determine respective prompts 154 for each of the sub-requests.

For example, the request 120 can be decomposed into one or more tasks for a particular LLM, e.g., as a sequence of prompts in a chain-of-thought framework that decomposes a complex task into a sequence of related sub-tasks that an LLM can consecutively perform to effectively complete the complex task. As another example, the request 120 can be decomposed into tasks that each correspond with different finetuned LLMs, e.g., to take advantage of a mixture-of-experts model included in the external LLMs 110.

In some cases, the input 150 can additionally include one or more response template(s) 156, e.g., an example of the desired structure for the output in response to the prompt(s) 154. As an example, a response template for a particular prompt can include a rephrasing of the prompt, a main response, a summary of the response, and suggested next steps. In the case that the task identification engine 160 has decomposed the request 120 into a sequence of prompts in a chain-of-prompt framework, the system 100 can include respective response templates 156 for each of the prompts 154 in the sequence of prompts that facilitate the consecutive prompting of the LLM.

For example, the system 100 can receive the response template(s) 156 from the client device 105, e.g., by way of the API 115. In particular, the system 100 can provide an API 115 that allows for the configuration of a response template 156 for the request 120. In this case, a user of the client device 105 can specify a particular response template 156 for the request 120.

As another example, the system 100 can identify one or more response template(s) 156, e.g., from previously used response template(s) maintained in a response template database 165. More specifically, the system 100 can store previously received response templates with associated data indicating the purpose of the template in the database 165. In some cases, the system 100 can use the LLMs 110 to generate response templates, e.g., by prompting one or more of the external LLMs 110 to generate a response template for a given prompt, and storing the response template in the database 165.

After determining the prompt(s) 154, relevant portion(s) of context 152, and response template(s) 156 necessary to respond to the request 120 as the input 150, the system 100 can process the input 150 using an LLM execution engine 170 and provide the input 150 to at least one of the external LLMs 110. For example, the LLM execution engine 170 can include a router that routes respective jobs for the input 150, where each job includes inputting corresponding relevant portion(s) of context 152, a prompt from the prompt(s) 154, and, in some cases, a response template from the response template(s) 156 to an external LLMs 110.

In particular, the LLM execution engine 170 can determine the execution strategy for the input 150, e.g., based on any relationships in the prompt(s) 154. As an example, the engine 170 can identify whether any of the one or more prompt(s) 154 can be executed parallel, e.g., by providing independent prompt(s), e.g., with corresponding context 152 and response template 156, to separate external LLMs 110. As another example, the engine 170 can determine whether a particular LLM in the external LLMs 110 is better suited to perform the task represented by a particular prompt, e.g., due to the particular LLM having been specialized for the task through finetuning. In this case, the engine 170 can provide the particular prompt to the particular LLM for the specialized task.

As yet another example, the engine 170 can designate whether any of the one or more prompt(s) 154 should be executed by multiple LLMs. As an example, the engine 170 can provide an additional input to the multiple LLMs to indicate that the LLM is part of a multiple-participant processing job for the prompt and to request that each of the multiple LLMs additionally process the generated results from all of the participating LLMs in the multiple-participant processing job to generate an indication of the value of the responses, e.g., by voting on a best response or assigning a score to the responses.

The system 100 can then receive the one or more response(s) from the LLMs 110 corresponding to the input 150. In particular, the system 100 can verify the completion of the execution strategy for the request 120 using a verification engine 180. For example, the verification engine 180 can determine whether a response was received for each of the prompt(s) 154 in the input 150. In the case that any response is missing, the system 100 can re-execute the prompt(s) corresponding with the missing responses. As another example, in the case that the prompt(s) 154 were accompanied by a response template(s) 156 in the input 150, the verification engine 180 can determine whether the responses received adhere to the relevant response template(s) 156.

The system 100 can also use the verification engine 180 to provide for workflow monitoring regarding inputted requests 120. For example, the verification engine 180 can log data regarding the responses received for different inputs 150. As an example, the system 100 can analyze the data, e.g., to support online improvement of the system, or to provide a user of the client device 105 with information regarding which execution strategies were most effective for responding to the request 120.

In the case that the system 100 receives a single response from the external LLMs 110 and verifies the response with the verification engine 180, the system 100 can perform actions based on the response using a performance engine 195. For example, the performance engine 180 can modify a text document based on the response, as discussed in more detail with reference to FIG. 2. In some situations, one or more of the actions performed by the performance engine 195 includes providing the response to the client device 105. In either case, the output 190 of the system 100 is based on the response received from the external LLMs. In some situations, one or more of the actions performed includes outputting a revised document (e.g., revised by the performance engine 195 based on the response) to the client device 105. In the case that the system receives multiple responses from the external LLMs 110, after verifying the responses with the engine 180, the system 100 can process the responses using a result aggregator engine 185, e.g., to synthesize the results. In this case, the result aggregator can combine the responses into an aggregated response and provide the aggregated response to the performance engine 195 to carry out the performance of actions based on the aggregated response.

FIG. 2 is an illustration of an example data flow 200 for modifying a document. The document modification illustrated by the example data flow 200 can be carried out, for example, by the system 100, and the document being modified can be larger than the maximum output window of available LLMs. The example data flow 200 begins with the client device 105 submitting a document analysis request 205 to the LLM management system 100. In some implementations, the document analysis 205 request is submitted as a completed request, or fully defined request, that is submitted to the LLM management system 100, for example, by way of an API. In these implementations, the details of the request can be configured at the client device, and the request can be submitted to the LLM management system 100 with all of the required attributes/parameters required to perform document modification analysis.

In some implementations, the document analysis request 205 is created through interaction with web application, including a graphical user interface, that can be provided by the LLM management system 100. The web application can enable the creation of the document analysis request 205 and/or other interactions through a series of interactions with the web application. The series of interactions can facilitate the specification of the attributes of the document analysis request 205 and/or other interactions. As used herein, an interaction defines a set of tasks that are to be performed by one or more LLMs. For example, an interaction can specify a set of tasks required to be performed by one or more LLMs to complete a document review and/or revision. Another interaction can be a set of tasks required to be performed by one or more LLMs to conduct an analysis of a contract to ensure compliance with company policies. Of course, other interactions can be created, and the examples described are to be considered non-limiting in nature.

An interaction is generally created by building an interaction definition. The interaction definition specifies one or more of (i) an interaction name of the interaction, (ii) an interaction description of the interaction, (iii) prompt segments, (iv) a schema, and (v) a configuration. The interaction name uniquely identifies the interaction from other interactions. For example, an interaction name for a grammar and spelling review interaction can be “Web Content Grammar and Spelling Review.” The interaction description provides a description of the interaction. For example, the interaction description for the “Web Content Grammar and Spelling Review” can be something such as “Review the spelling and grammar of web page content based on the source files written in markdown.” The prompt segments provide a list of prompts and/or prompt templates that are rendered as part of a set of interaction prompts for the interaction. For example, the prompt segments for the “Web Content Grammar and Spelling Review” (“WCGPR”) interaction can include a “proofreader” prompt such as:

You are a professional proofreader and editor. Your task is to review
the spelling and grammar of web page content based on markdown
source files. Identify issues including misspelled words and major
grammatical errors. Do not spell check any code in the documentation,
only the text explaining code. Also, note that the company name has
changed from ‘Corp I’ to ‘Corp IA’, so identify any place
where the name should be updated.

Upon execution of the WCGPR interaction, the above prompt will be provided to the one or more LLMs along with the document to be reviewed, thereby instructing the one or more LLMs on the actions to be performed. For example, the prompt above is instructing the one or more LLMs how to process the document and specific changes that are to be made to the document (e.g., changing the company name from “Corp 1” to “Corp 1A”).

The schema specifies a structured format for the response. In some implementations, the schema is a JavaScript Object Notation Schema. The schema can specify, for example, the types of data that are to be returned by the LLMs in response to the prompts. In a specific example, the schema for the WCGPR interaction could be as follows:

```
issues object[ ]
      phrase string
      line_numbers integer[ ]
explanation string
recommendation string.
```

In this example, the schema specifies that the LLM should return an response that specifies issues identified in the document being reviewed based on the prompt provided above, with the phrase at issue being presented as a character string, the line_numbers at which the issue occurred being specified in the form of integers, the explanation of the issue identified being presented as a character string, and the recommendation of how to resolve the issue being presented as a character string. An example structured response generated by an LLM according to the above-presented schema is as follows:

```
{
  “issues”: [
  {
    “phrase”: “Corp 1”,
    “line_numbers”: [
    3,
    11,
    13
    ],
    “explanation”: “The company name has changed from ‘ Corp 1’ to ‘ Corp 1A’.”,
    “recommendation”: “Replace ‘Corp 1’ with ‘Corp 1A””
  },
  {
    ‘phrase”: “It needs to retur a string.”,
    “line_numbers”: [
    28
    ],
    “explanation”: “The word ‘return’ is misspelled.”,
    “recommendation”: “It needs to return a string.”
  },
  {
    “phrase”: “They define the tasks the LLM are requested to perform.”,
    “line_numbers”: [
    43
    ],
    “explanation”: “Incorrect subject-verb agreement. ‘LLM’ (Language Model) should be
treated as singular.”,
    “recommendation”: “They define the tasks the LLM is requested to perform.”
  },
  {
    “phrase”: “< AWS Bedrock are supported.”,
    “line_numbers”: [
    95
    ],
    “explanation”: “Incorrect subject-verb agreement. ‘AWS Bedrock’ should be treated as
singular.”,
    “recommendation”: “AWS Bedrock is supported.”
  },
  {
    “phrase”: “Replicate are supported.”,
    “line_numbers”: [
    99,
    100
    ],
    “explanation”: “Incorrect subject-verb agreement. ‘Replicate’ should be treated as
singular.”,
    “recommendation”: “Replicate is supported.”
  },
  {
    “phrase”: “Huggingface Inference Endpoints are supported.”,
    “line_numbers”: [
    104,
    105
    ],
    “explanation”: “The company name ‘Hugging Face’ is typically written with a space.”,
    “recommendation”: “Hugging Face Inference Endpoints are supported.”
  }
  ]
}
```

The configuration of the interaction definition specifies, for each of the one or more LLMs, an environment that connects to an inference provider of the LLM, a model to execute the interaction, and execution parameters. For example, the configuration of the interaction definition can specify that the environment for the interaction is AWS Bedrock US East-1, that the model used to execute the interaction is the Anthropic 3.5 Sonnet, as well as a maximum number of tokens and whether run data is stored for model inputs and/or outputs. The specifics provided herein are only for purposes of example, different configurations can be specified.

The document analysis request 205 can also include a reference to the document to be analyzed/modified. For example, the document analysis request 205 can include a file path, uniform resource, locator, or another reference to the location at which the document to be analyzed/modified is located and/or from which the document is retrievable. For example, the document analysis request 205 can specify a location within the content database 140 from which the document to be analyzed/modified is retrievable. In some implementations, content of the document to be analyzed/modified can be included with the document analysis request 205. The document to be analyzed/modified is referred to as the target document 210.

In response to receiving the document analysis request 205, the LLM management system 100 identifies the target document 210. For example, the LLM management system 100 can parse the document analysis request 205 to determine that the target document 210 is stored at a location within the content database 140, e.g., based on the identification of a file path included in the document analysis request 205. Based on this determination, the LLM management system 100 retrieves, or otherwise obtains, the target document (“target doc”) 210 from the content database 140.

The LLM management system 100 inserts a set of reference points at different locations of the target document 210 to generate a version of the target document 210 that includes the reference points, which is referred to as a referenced document 215. The set of reference points can be inserted into the target document 210 before the receipt of the document analysis request 205, or when the target document 210 is obtained responsive to receiving the document analysis request 205. The set of reference points are markers that segment the target document 210, and provide a basis for identifying different locations within the target document 210. In some implementations, the set of reference points are line numbers that are inserted into the content of the target document 210 to specify where each line of the target document is located. In this way, any LLM that analyzes the referenced document 215 can identify and specify the line number of the reference document 215 on which any issues were identified, e.g., similar to the manner illustrated by the example structured response above.

FIG. 2 includes an illustration of the creation of the referenced document 215 by the LLM management system 100. As shown, after the LLM management system 100 obtains the target document 210 from the content database 140, the LLM management system 100 can analyze the content and/or structure of the target document 210 to identify the line breaks in the target document 210. For example, upon analysis of the target document 210, the LLM management system 100 can determine that the first line of the target document includes the text “Aaaaaaaaaaaaa,” while the second line of the target document includes the text “Bbbbbbbbbbbbb,” and so on, until the LLM management system 100 detects the end of the content at the end of the line that includes the text “Zzzzzzzzzzzzzzz.” The LLM management system 100 can use the content and/or structure of the document to insert the line numbers into the content of the target document 210, a copy of the content of the target document, or another representation of the content of the target document (e.g., formatted for consumption by the LLM 110). The insertion of the line numbers is visually represented in the depiction of the referenced document 215. The line numbers can be inserted in a manner so that they are identifiable by the LLM 110 and/or otherwise distinguishable from the native text of the target document 210. In this way, the LLM 110 will be able to distinguish the line numbers from the native text of the target document 210, and use the line numbers as reference points for specifying locations of the target document 210 that need to be revised to achieve any proposed modifications, which can also be considered achieving a target state of the target document 210.

In some situations, proposed modifications can be expressly specified prior to running an interaction. For example, the interaction definition can include a prompt instructing the LLM to remove, add, or modify certain content, such as a limited liability clause in a contract, which is an example of an expressly specified proposed modification. In other situations, the proposed modifications can be conditional in nature, such as spelling and grammar modifications. In these situations, the specifics of the proposed modifications, such as “delete X clause” need not be expressly stated at the time the interaction definition is created. Rather, the proposed modifications can be general in nature, such as “review the contract for spelling and grammar errors, and provide recommendations for correcting the spelling and grammar errors,” such that the specific individual modifications to be made are not known prior to execution of the interaction. In the more general definition of the proposed modifications, such as the spelling and grammar error correction, the types of actions required to be performed to make modifications within the more general proposed modification definition will be determined by the LLM 110 during the analysis stage of document review.

The LLM management system 100 creates an input 220, also referred to as an LLM input, describing a set of proposed analysis tasks and/or modifications (e.g., to the target document 210) that are desired. For example, the input 220 can include instructions that specify particular types of content that should be added, removed, or modified (e.g., rewritten) based on the analysis of the document. In a specific example, the prompt provided above can be included in the input 220. That example prompt instructs the LLM that the company name has changed from ‘Corp 1’ to ‘Corp 1A’, and that the company name should be updated wherever it is incorrectly recited by the reference document 215 (and target document 210). The example prompt above also instructs the LLM to identify instances of grammar or spelling errors in the document. The input 220 can be created, at least in part, based on the prompt segments of the interaction definition and/or other input. For example, the prompt segments can include placeholders that are populated based on specific information input prior to run time of the interaction. In this way, the prompt segments can be templatized so that they can be used across different interactions and customized to identify different specific document content for different interactions and/or evaluation of different documents.

More generally, the input 220 created by the LLM management system 100 can describe a set of proposed modifications to the target document 210. The set of proposed modifications can include one or more of replacements of terms/phrases/clauses, corrections of errors (e.g., spelling, grammar, etc.), identification of certain words/phrases/clauses, addition of certain words/phrases/clauses that are not found in the reference document 215 (and therefore the target document 210), or deletion of certain words/phrases/clauses that are to be removed when identified in the reference document 215 (and therefore the target document 210).

The LLM management system 100 can generate the input 220 to include instructions that cause the LLM to generate a response that includes, for each given proposed modification among the set of proposed modifications, (i) a corresponding action required to achieve the given proposed modification and (ii) one or more reference points specifying one or more locations of the referenced document and/or textual electronic document at which the corresponding action is required to be performed to achieve the given proposed modification. In other words, the input 220 created by the LLM management system 100 instructs the LLM 110 to generate a response specifying actions that need to be taken to achieve the desired modifications of the target document 210, and the locations (e.g., line numbers) where the actions need to be performed. The target document 210 is the document to which the desired modifications are to be applied, but it should be understood that the LLM 110 will be processing the referenced document 215 to utilize the inserted reference points to specify where corresponding actions to content of the target document, which is included in both of the target document 210 and the referenced document 215.

In some implementations, the input 220 can include instructions that cause the response generated by the LLM 110 to use a set of defined instructions that the LLM management system 100 can use to make the proposed modifications. For example, the input 220 can cause the LLM 110 to specify the corresponding action for a proposed modification as one of an insert operation, delete operation, or rewrite operation, thereby enabling the LLM management system 100 to accurately revise content of the target document 210 in the manner the LLM 110 would have modified the document. In this way, the LLM management system 100 can leverage the power of the LLM 110 to identify how content of the target document 210 needs to be modified to achieve the desired result, as well as modify content of the target document 210 without having the LLM 110 perform the modifications, which as previously discussed is not possible when the size of the target document 210 (and therefore the referenced document 215) is larger than the output window of the LLM 110.

The input 220 created by the LLM management system 100 can also include the referenced document 215 and any other information available to the LLM management system 100, such as the interaction definition, and any other parameters.

The LLM management system 100 submits the input 220 to one or more of the external LLMs 110. For purposes of this discussion, we will assume that the input 220 is submitted to one LLM 110, but the input 220 could be submitted to multiple LLMs as previously discussed. The input 220 can be submitted to the LLM 110, for example, by transmitting the entirety of the input 220 to the LLM 110. The input 220 can also be submitted to the LLM 110 by transmitting a set of instructions that instruct the LLM 110 where to access one or more portions of the input 220. For example, the LLM management system 110 may transmit, to the LLM 110, a set of instructions that direct the LLM 110 to a storage location at which the LLM 110 can access the referenced document 215, rather than transmitting the entirety of the referenced document 215 to the LLM 110 in a same package as other parts of the input 220. This may reduce the latency associated with submitting the input 220 to the LLM 110, for example, by not requiring the entirety of the referenced document 215 to be transmitted to the LLM 110 before the LLM begins processing the input 220.

The LLM 110 uses the input 220 to analyze the referenced document 215 according to the input 220, and generates a response based on the analysis and in accordance with the input 220. The response can be a structured response 225 formatted according to the schema specified in the input 220. For example, the response can be a JSON compliant response that specifies the actions required to achieve a proposed modification and the locations of the referenced document 215 (and therefore the target document) at which the actions need to be performed to achieve the proposed modification.

The LLM management system 110 receives, from the LLM 110, the structured response 225, for example, over a telecommunications network link. As noted above, the structured response 225 will be formatted according to the schema specified in the interaction definition. The contents of the structured response 225 will include an action required to be performed to achieve a given modification to content of the target document 210 and information specifying the location within content of the target document 210 at which the action needs to be performed to achieve the given modification. For example, assume that the given modification is deletion of a limited liability clause in a contract. In this example, the LLM 110 will identify the location of the limited liability clause in the contract (e.g., based on the input 220), and generate a response identifying a section of the contract (e.g., target document 210) to delete to achieve the removal of the limited liability clause. An example of a structured response 225 in this scenario can be as follows:

```
{
  “issues”: [
  {
    “contract section”: “Limited Liability Clause”,
    “line_numbers”: [
    2
    3
    4
    ],
    “explanation”: “The contract includes a limited liability clause that
    should be removed”, “recommendation”: “Delete full sentences at
    lines 2-4”
  },
    ]
{
```

In this example, the structured response 225 includes a corresponding action to take to achieve the removal of the limited liability clause from the target document 210, as well as the location of the target document at which the corresponding action needs to be performed to achieve the desired removal of the limited liability clause. More specifically, the structured response 225 indicates that the limited liability clause is located at lines 2-4 of the reference document 215 analyzed by the LLM 110 (and therefore the target document 210), and that to remove the limited liability clause, full sentences located between lines 2-4 of the target document need to be deleted.

The LLM management system 100 processes the structured response 225, and transforms the target document 210 by performing actions specified in the structured response 225. For example, the LLM management system 100 can parse the structured response 225 to identify each issue identified by the LLM management system 100 during analysis of the referenced document 215. More specifically, the LLM management system 100 can identify the recommendation, which is a corresponding action required to achieve the proposed modification, and the line numbers specifying locations of the referenced document 215 (and therefore content of the target document 210) at which the corresponding action needs to be performed.

Returning to the last example, the structured response 225 specified that the limited liability clause is located at lines 2-4 of the reference document 215 analyzed by the LLM 110 (and therefore the target document 210), and that to remove the limited liability clause, full sentences located between lines 2-4 of the content of the target document need to be deleted. In this example, the LLM management system 100 can parse that portion of the structured response 225, and execute a delete operation that removes the full sentences located between rows 2-4 from the referenced document 215 (or the target document 210), resulting in a revised document 230.

For example, FIG. 2 shows the LLM management system 100 deleting the text of rows 2-4 of the referenced document 215, to arrive at the revised document 230. The deletion of the text is shown using markup to provide a visual aid for purposes of example, but the deletion of the text of rows 2-4 would remove the text from the referenced document 215.

In some implementations, the LLM management system 100 performs the corresponding actions specified by the structured response 225 on the referenced document 215. For example, the referenced document 215 includes the line numbers in a known format/structure, such that the LLM management system 100 can use the line numbers within the referenced document 215 to perform the corresponding actions at the specified locations according to the structured response 225. After the corresponding actions have been performed, the LLM management system 100 can remove the line numbers to arrive at the revised version of the referenced document (e.g., 230) and then remove the line numbers to arrive at a revised version of the target document. Once the corresponding actions have been performed according to the structured response 225, the content of the textual electronic document is considered to have been transformed into a revised document, irrespective of whether the line numbers have been removed.

In some implementations, the LLM management system 100 can perform the corresponding actions (e.g., deletion of the sentences between rows 2-4) on the target document 210 itself to transform content of the target document into the revised document 210. This may be possible, for example, where a native format of the target document makes the line numbers of the target document readily available to the LLM management system 100. In this scenario, the target document itself can be modified based on the structured response, as discussed above.

The LLM management system 100 can output the revised document 230 to the client device 105 in a request response 235. The request response 235 is the response of the LLM management system 100 to the document analysis request 205 previously submitted by the client device 105. As such, the request response 235 can include one or more of the revised document 230, an explanation of the revisions made to the document, and/or a markup version of the target document showing the changes that have been made to the target document. In some implementations, the request response 235 can include a human interpretable version of the structured response 225. For example, the LLM management system 100 can convert the structured response 225 into a format that is readable by users of the client device 105 that are not aware of how to parse the structured response 225. In some implementations, the request response 235 can include the structured response 225, thereby providing the client device 105 and/or any applications executing at the client device with access to the response of the LLM that is formatted according to the schema of the interaction definition. In this way, the client device 105 can input the structured response 225 into other applications for further processing and/or analytical analysis.

FIG. 3 is a flow chart of an example process 300 for utilizing a large language model (“LLM”) to modify a document, and more particularly, to modify a document that is larger than the output window of the LLM. The process 300 can be performed by one or more data processing apparatus, such as data processing apparatus included in the LLM management system 100 discussed above with reference to FIG. 1. Operations of the process 300 can also be performed by one or more data processing apparatus configured to interact with a data storage device and execute instructions that cause the one or more data processing apparatus to perform, or otherwise carry out, operations of the process 300. Operations of the process 300 can also be implemented as instructions stored on one or more computer readable medium (e.g., non-transitory computer readable medium). Execution of the instructions by one or more data processing apparatus (e.g., computing devices) cause the one or more data processing apparatus to perform operations of the process 300.

A textual electronic document is obtained by a system that is connected between a client device and one or more large language models (LLMs) (310). In some implementations, the textual electronic document is larger than the output window of the one or more LLMs. For example, the textual electronic document can have a token size that exceeds a maximum output window of the one or more LLMs, such that the one or more LLMs are prevented from creating a revised document of the size required to perform one or more proposed modifications on the textual electronic document. In other words, the maximum output window (e.g., maximum number of tokens that can be output by the one or more LLMs in a single response) is not large enough to generate a revised document that results from performing, for each given proposed modification in a set of proposed modifications, a corresponding action at the one or more locations of the textual electronic document and/or the referenced document.

In some implementations, the textual electronic document can be obtained in response to receiving, or with, a request from a client device. For example, the system can receive, from a client device, a request specifying one or more changes to be made to the textual electronic document. The request itself can include the textual electronic document (e.g., a representation of content included in the textual electronic document), or the request can include a file path, web location, or another location from which the textual electronic document can be obtained (e.g., requested, accessed, or retrieved).

In some implementations, the system can also receive, as input from the client device, an interaction definition. An interaction definition is a set of parameters that define an interaction. The interaction definition can specify, for example, (i) an interaction name of the interaction, (ii) an interaction description of the interaction, (iii) prompt segments, (iv) a schema, and (v) a configuration. As previously discussed, the interaction defines a set of tasks the one or more LLMs are being requested to perform, the interaction name uniquely identifies the interaction from other interactions, the interaction description provides a description of the interaction, the prompt segments provide a list of prompts/prompt templates that are rendered as part of a full prompt provided to the one or more LLMs, the schema specifies a structured format for the response, and the configuration specifies, for each of the one or more LLMs, an environment that connects to an inference provider of the LLM, a model to execute the interaction, and execution parameters. For brevity the details discussions of these parameters, which were previously discussed, are not repeated here. As previously discussed, the interaction definition can be created at the client side and provided to the system by way of an API, or the interaction definition can be built through a graphical user interface of an application provided by the system.

The system inserts reference points at different locations within the content of the textual electronic document to generate a referenced document that includes the reference points (320). As previously discussed, the reference points can be line numbers, such that insertion of the reference points can be achieved by inserting line numbers into the textual electronic document.

The system creates an LLM input describing a set of proposed modifications to the textual electronic document (330). In some implementations, the LLM input includes instructions that cause the one or more LLMs to generate a response that includes, for each given proposed modification in the set of proposed modifications, (i) a corresponding action required to achieve the given proposed modification and (ii) one or more reference points specifying one or more locations of the referenced electronic document (and therefore content of the target document) at which the corresponding action is required to be performed to achieve the given proposed modification. For example, as previously discussed, the LLM input can instruct the one or more LLMs to review content of the textual electronic document for spelling and/or grammar issues, revise a document in a manner specified in the request received from the client device (e.g., remove the limited liability clause and any references thereto), ways to improve the readability, tone, etc., of the content of the textual electronic document, etc.). Moreover, the system can generate the LLM input based on any other changes specified by the request. For example, the request may specify that the content of the textual electronic document should be reviewed and revised to redact certain information, change terminology (e.g., from “phrase 1” to “phrase 2”, or make other specific changes to the content of the textual electronic document. As previously discussed, the changes specified by the request can be specific in nature (e.g., replace “phrase 1” with “phrase 2”), or more general in nature (e.g., review the document for spelling and grammar issues).

The system can also create at least a portion of the LLM input by generating instructions that causes the one or more LLMs to specify, as a corresponding action required to achieve a given proposed modification, one of an insert operation, a delete operation, or a rewrite operation. For example, in situations where achieving a given proposed modification requires removal of content from the textual electronic document, the LLM input can include data instructing the one or more LLMs to return a response specifying that a delete operation be performed on a specific set of text at a specific line number (or range of line numbers) of the textual electronic document. In a situation where additional content needs to be included in the textual electronic document to achieve the given proposed modification (e.g., adding a particular section to a contract or book), the LLM input can include data instructing the one or more LLMs to return a response specifying that an insert operation be performed to insert a specified set of text content at a specific location (e.g., line number) of the textual electronic document. With respect to replacing terms, phrases, or sections of the textual electronic document, the LLM input can include data instructing the one or more LLMs to return a response specifying a rewrite operation be performed along with the proposed rewrite content and line number(s) at which the rewrite operation be performed to achieve the given proposed modification.

The system submits the LLM input to the one or more LLMs (340). The LLM input can be submitted to the one or more LLMs, for example, by transmitting the LLM input to the one or more LLMs over a telecommunications network. The one or more LLMs may be external to the system, and the one or more LLMs may provide APIs for connecting to the one or more LLMs, and submitting the LLM input to the one or more LLMs. In these situations, the system can submit the LLM input to the one or more LLMs utilizing the provided APIs.

The system receives a response from the one or more LLMs (350). The response is received in response to submission of (as a reply to) the LLM input to the one or more LLMs. In some implementations, the response includes, for each given proposed modification in the set of proposed modifications, (i) the corresponding action required to achieve the given proposed modification and (ii) the one or more reference points specifying one or more locations of the referenced document (and therefore the content of the textual electronic document) at which the corresponding action is required to be performed to achieve the given proposed modification. The response received can be a structured response formatted in accordance with the schema of the interaction definition, which is discussed above. For brevity those details are not repeated here.

The system transforms content of the textual electronic document into a revised document. (360). In some implementations, the system achieves the transformation by performing, for each given proposed modification in the set of proposed modifications, the corresponding action required to achieve the proposed modification. For example, the system can perform each insert operation, delete operation, and/or rewrite operation specified in the response from the one or more LLMs. Each of the corresponding actions can be performed at the one or more locations specified by the one or more reference points included in the response from the one or more LLMs. As previously discussed, the response will specify, for each corresponding action, the location of the electronic document (e.g., using reference points, such as line numbers) at which the corresponding action needs to be performed. The system can use this information to perform the corresponding actions at the correct locations within the content of the textual electronic document (either in the referenced document, the textual electronic document, or another document that includes the content of the textual electronic document) to achieve the set of proposed medications. When line numbers are used as the reference points, the transformation can be achieved by performing, for each given proposed modification in the set of proposed modifications, the corresponding action at the one or more locations specified by the one or more line numbers.

The system outputs the revised document to a client device (370). As previously discussed, the revised document can be output to the client device in various ways. For example, the revised document can be provided in a graphical user interface generated by the system and presented at the client device. The revised document can also be provided as a file transmitted to the client device. In some implementations, the output of the revised document to the client device is a response to the request previously submitted by/received from the client device. In some implementations, the revised document output can include one or more of the revised document, an explanation of the revisions made to the document, and/or a markup version of the target document showing the changes that have been made to the target document. In some implementations, the output can include a human interpretable version of the structured response. For example, the system can convert the structured response received from the one or more LLMs into a format that is readable by users of the client device that are not aware of how to parse the structured response. In some implementations, the request response can include the structured response itself, thereby providing the client device and/or any applications executing at the client device with access to the response of the LLM that is formatted according to the schema of the interaction definition. In this way, the client device can input the structured response into other applications for further processing and/or analytical analysis.

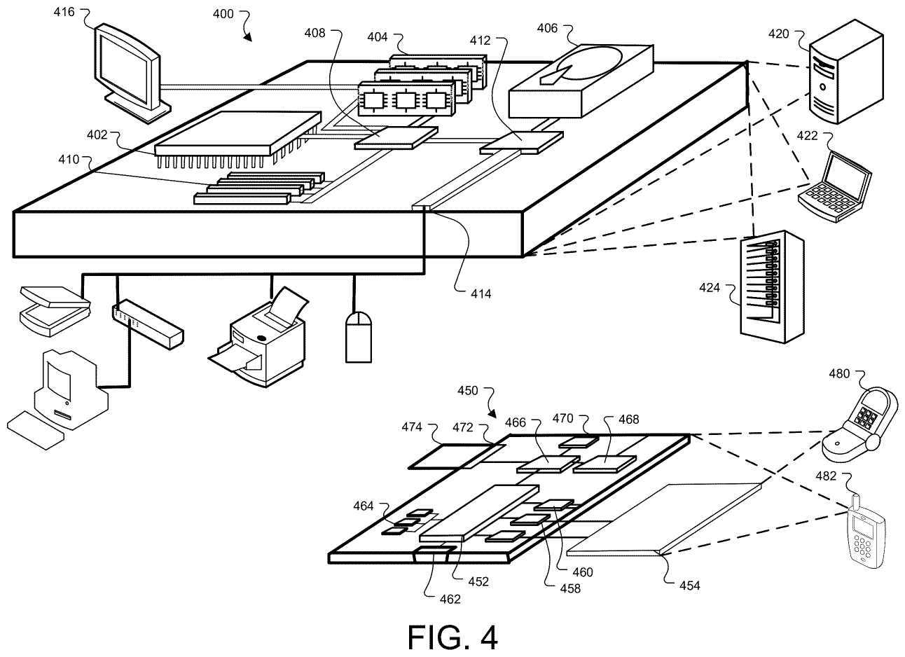

FIG. 4 shows an example of example computer device 400 and example mobile computer device 450, which can be used to implement the techniques described herein. For example, a portion or all of the operations for transforming a textual electronic document into multiple different sub-documents, identifying one or more sub-documents in response to receiving a document analysis request, and providing the identified sub-documents as input to at least one external LLM, etc. may be executed by the computer device 400 and/or the mobile computer device 450. Computing device 400 is intended to represent various forms of digital computers, including, e.g., laptops, desktops, workstations, personal digital assistants, servers, blade servers, mainframes, and other appropriate computers. Computing device 450 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 400 includes processor 402, memory 404, storage device 406, high-speed interface 408 connecting to memory 404 and high-speed expansion ports 410, and low-speed interface 412 connecting to low-speed bus 414 and storage device 406. Each of components 402, 404, 406, 408, 410, and 412, are interconnected using various busses, and can be mounted on a common motherboard or in other manners as appropriate. Processor 402 can process instructions for execution within computing device 400, including instructions stored in memory 404 or on storage device 406 to display graphical data for a GUI on an external input/output device, including, e.g., display 416 coupled to high-speed interface 408. In other implementations, multiple processors and/or multiple busses can be used, as appropriate, along with multiple memories and types of memory. Also, multiple computing devices 400 can be connected, with each device providing portions of the necessary operations (e.g., as a server bank, a group of blade servers, or a multi-processor system).

Memory 404 stores data within computing device 400. In one implementation, memory 404 is a volatile memory unit or units. In another implementation, memory 404 is a non-volatile memory unit or units. Memory 404 also can be another form of computer-readable medium (e.g., a magnetic or optical disk. Memory 404 may be non-transitory.)

Storage device 406 is capable of providing mass storage for computing device 400. In one implementation, storage device 406 can be or contain a computer-readable medium (e.g., a floppy disk device, a hard disk device, an optical disk device, or a tape device, a flash memory or other similar solid state memory device, or an array of devices, such as devices in a storage area network or other configurations.) A computer program product can be tangibly embodied in a data carrier. The computer program product also can contain instructions that, when executed, perform one or more methods (e.g., those described above.) The data carrier is a computer- or machine-readable medium, (e.g., memory 404, storage device 406, memory on processor 402, and the like.)

High-speed controller 408 manages bandwidth-intensive operations for computing device 400, while low-speed controller 412 manages lower bandwidth-intensive operations. Such allocation of functions is an example only. In one implementation, high-speed controller 408 is coupled to memory 404, display 416 (e.g., through a graphics processor or accelerator), and to high-speed expansion ports 410, which can accept various expansion cards (not shown). In the implementation, low-speed controller 412 is coupled to storage device 406 and low-speed expansion port 414. The low-speed expansion port, which can include various communication ports (e.g., USB, Bluetooth®, Ethernet, wireless Ethernet), can be coupled to one or more input/output devices, (e.g., a keyboard, a pointing device, a scanner, or a networking device including a switch or router, e.g., through a network adapter.)

Computing device 400 can be implemented in a number of different forms, as shown in the figure. For example, it can be implemented as standard server 420, or multiple times in a group of such servers. It also can be implemented as part of rack server system 424. In addition, or as an alternative, it can be implemented in a personal computer (e.g., laptop computer 422.) In some examples, components from computing device 400 can be combined with other components in a mobile device (not shown), e.g., device 450. Each of such devices can contain one or more of computing device 400, 450, and an entire system can be made up of multiple computing devices 400, 450 communicating with each other.

Computing device 450 includes processor 452, memory 464, an input/output device (e.g., display 454, communication interface 466, and transceiver 468) among other components. Device 450 also can be provided with a storage device, (e.g., a microdrive or other device) to provide additional storage. Each of components 450, 452, 464, 454, 466, and 468, are interconnected using various buses, and several of the components can be mounted on a common motherboard or in other manners as appropriate.

Processor 452 can execute instructions within computing device 450, including instructions stored in memory 464. The processor can be implemented as a chipset of chips that include separate and multiple analog and digital processors. The processor can provide, for example, for coordination of the other components of device 450, e.g., control of user interfaces, applications run by device 450, and wireless communication by device 450.

Processor 452 can communicate with a user through control interface 458 and display interface 456 coupled to display 454. Display 454 can be, for example, a TFT LCD (Thin-Film-Transistor Liquid Crystal Display) or an OLED (Organic Light Emitting Diode) display, or other appropriate display technology. Display interface 456 can comprise appropriate circuitry for driving display 454 to present graphical and other data to a user. Control interface 458 can receive commands from a user and convert them for submission to processor 452. In addition, external interface 462 can communicate with processor 442, so as to enable near area communication of device 450 with other devices. External interface 462 can provide, for example, for wired communication in some implementations, or for wireless communication in other implementations, and multiple interfaces also can be used.

Memory 464 stores data within computing device 450. Memory 464 can be implemented as one or more of a computer-readable medium or media, a volatile memory unit or units, or a non-volatile memory unit or units. Expansion memory 474 also can be provided and connected to device 450 through expansion interface 472, which can include, for example, a SIMM (Single In Line Memory Module) card interface. Such expansion memory 474 can provide extra storage space for device 450, or also can store applications or other data for device 450. Specifically, expansion memory 474 can include instructions to carry out or supplement the processes described above, and can include secure data also. Thus, for example, expansion memory 474 can be provided as a security module for device 450, and can be programmed with instructions that permit secure use of device 450. In addition, secure applications can be provided through the SIMM cards, along with additional data, (e.g., placing identifying data on the SIMM card in a non-hackable manner.)

The memory 464 can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer- or machine-readable medium (e.g., memory 464, expansion memory 474, and/or memory on processor 452), which can be received, for example, over transceiver 468 or external interface 462.

Device 450 can communicate wirelessly through communication interface 466, which can include digital signal processing circuitry where necessary. Communication interface 466 can provide for communications under various modes or protocols (e.g., GSM voice calls, SMS, EMS, or MMS messaging, CDMA, TDMA, PDC, WCDMA, CDMA2000, or GPRS, among others.) Such communication can occur, for example, through radio-frequency transceiver 468. In addition, short-range communication can occur, e.g., using a Bluetooth®, WiFi, or other such transceiver (not shown). In addition, GPS (Global Positioning System) receiver module 470 can provide additional navigation- and location-related wireless data to device 450, which can be used as appropriate by applications running on device 450. Sensors and modules such as cameras, microphones, compasses, accelerators (for orientation sensing), etc. may be included in the device.

Device 450 also can communicate audibly using audio codec 460, which can receive spoken data from a user and convert it to usable digital data. Audio codec 460 can likewise generate audible sound for a user, (e.g., through a speaker in a handset of device 450.) Such sound can include sound from voice telephone calls, can include recorded sound (e.g., voice messages, music files, and the like) and also can include sound generated by applications operating on device 450.

Computing device 450 can be implemented in a number of different forms, as shown in the figure. For example, it can be implemented as cellular telephone 480. It also can be implemented as part of smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined, or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. A computer-implemented method, comprising:
obtaining, by a system that is connected between a client device and one or more large language models (LLMs), a textual electronic document;
inserting, by the system, reference points at different locations within the textual electronic document to generate a referenced document that includes the reference points;
creating, by the system, an input describing a set of proposed modifications to the textual electronic document, wherein the prompt includes instructions that cause the one or more LLMs to generate a response that includes, for each given proposed modification in the set of proposed modifications, (i) a corresponding action required to achieve the given proposed modification and (ii) one or more of the reference points specifying one or more locations of the referenced document at which the corresponding action is required to be performed to achieve the given proposed modification;
submitting, by the system, the input to the one or more LLMs;
receiving, by the system and from the one or more LLMs, the response that includes, for each given proposed modification in the set of proposed modifications, (i) the corresponding action required to achieve the given proposed modification and (ii) the one or more of the reference points specifying one or more locations of the referenced electronic document at which the corresponding action is required to be performed to achieve the given proposed modification;
transforming, by the system, content of the textual electronic document into a revised document by performing, for each given proposed modification in the set of proposed modifications, the corresponding action, required to achieve the proposed modification, at the one or more locations specified by the one or more reference points; and
outputting, by the system, the revised document to a client device.

2. The method of claim 1, further comprising receiving, by the system and from the client device, a request specifying one or more changes to be made to the textual electronic document, wherein creating the input describing a set of proposed modifications to the textual electronic document by the one or more LLMs comprises generating the input based on the changes specified by the request.

3. The method of claim 2, wherein creating the input comprises generating instructions that cause the one or more LLMs to specify, as the corresponding action for a given proposed modification, one of an insert operation, delete operation, or rewrite operation required to achieve the given proposed modification.

4. The method of claim 3, further comprising:
receiving, as input from the client device, an interaction definition specifying (i) an interaction name of the interaction, (ii) an interaction description of the interaction, (iii) prompt segments, (iv) a schema, and (v) a configuration, wherein:
the interaction defines a set of tasks the one or more LLMs are being requested to perform;
the interaction name uniquely identifies the interaction from other interactions;
the interaction description provides a description of the interaction;
the prompt segments provide a list of prompt templates that are rendered as part of the prompt;
the schema specifies a structured format for the response;
the configuration specifies, for each of the one or more LLMs, an environment that connects to an inference provider of the LLM, a model to execute the interaction, and execution parameters.

5. The method of claim 1, wherein the textual electronic document has a token size that exceeds a maximum output window of the one or more LLMs that prevents the one or more LLMs from creating the revised document resulting from performing, for each given proposed modification in the set of proposed modifications, the corresponding action at the one or more locations specified by the one or more of the reference points.

6. The method of claim 1, wherein inserting the reference points comprises inserting line numbers into the content of the textual electronic document, wherein transforming the referenced document into a revised document comprises transforming the referenced document into a revised document by performing, for each given proposed modification in the set of proposed modifications, the corresponding action at the one or more locations specified by the one or more of the line numbers.

7. A system that is connected between a client device and one or more large language models (LLMs), comprising:
one or more memory devices; and
one or more data processing apparatus configured to interact with the one or more memory devices and execute instructions that, upon execution, cause the one or more data processing apparatus to perform operations comprising:
obtaining a textual electronic document;
inserting reference points at different locations within the textual electronic document to generate a referenced document that includes the reference points;
creating an input describing a set of proposed modifications to the textual electronic document, wherein the prompt includes instructions that cause the one or more LLMs to generate a response that includes, for each given proposed modification in the set of proposed modifications, (i) a corresponding action required to achieve the given proposed modification and (ii) one or more of the reference points specifying one or more locations of the referenced document at which the corresponding action is required to be performed to achieve the given proposed modification;
submitting the input to the one or more LLMs;
receiving, from the one or more LLMs, the response that includes, for each given proposed modification in the set of proposed modifications, (i) the corresponding action required to achieve the given proposed modification and (ii) the one or more of the reference points specifying one or more locations of the referenced electronic document at which the corresponding action is required to be performed to achieve the given proposed modification;
transforming content of the textual electronic document into a revised document by performing, for each given proposed modification in the set of proposed modifications, the corresponding action, required to achieve the proposed modification, at the one or more locations specified by the one or more reference points; and
outputting the revised document to a client device.

8. The system of claim 7, wherein the instructions cause the one or more data processing apparatus to perform operations further comprising receiving, from the client device, a request specifying one or more changes to be made to the textual electronic document, wherein creating the input describing a set of proposed modifications to the textual electronic document by the one or more LLMs comprises generating the input based on the changes specified by the request.

9. The system of claim 8, wherein creating the input comprises generating instructions that cause the one or more LLMs to specify, as the corresponding action for a given proposed modification, one of an insert operation, delete operation, or rewrite operation required to achieve the given proposed modification.

10. The system of claim 9, wherein the instructions configure the one or more data processing apparatus to perform operations further comprising:
receiving, as input from the client device, an interaction definition specifying (i) an interaction name of the interaction, (ii) an interaction description of the interaction, (iii) prompt segments, (iv) a schema, and (v) a configuration, wherein:
the interaction defines a set of tasks the one or more LLMs are being requested to perform;
the interaction name uniquely identifies the interaction from other interactions;
the interaction description provides a description of the interaction;
the prompt segments provide a list of prompt templates that are rendered as part of the prompt;
the schema specifies a structured format for the response;
the configuration specifies, for each of the one or more LLMs, an environment that connects to an inference provider of the LLM, a model to execute the interaction, and execution parameters.

11. The system of claim 7, wherein the textual electronic document has a token size that exceeds a maximum output window of the one or more LLMs that prevents the one or more LLMs from creating the revised document resulting from performing, for each given proposed modification in the set of proposed modifications, the corresponding action at the one or more locations specified by the one or more of the reference points.

12. The system of claim 7, wherein inserting the reference points comprises inserting line numbers into the content of the textual electronic document, wherein transforming the referenced document into a revised document comprises transforming the referenced document into a revised document by performing, for each given proposed modification in the set of proposed modifications, the corresponding action at the one or more locations specified by the one or more of the line numbers.

13. One or more non-transitory computer readable medium storing instructions that, upon execution by one or more data processing apparatus of a system that is connected between a client device and one or more large language models (LLMs), cause the one or more data processing apparatus to perform operations comprising:
obtaining a textual electronic document;
inserting reference points at different locations within the textual electronic document to generate a referenced document that includes the reference points;
creating an input describing a set of proposed modifications to the textual electronic document, wherein the prompt includes instructions that cause the one or more LLMs to generate a response that includes, for each given proposed modification in the set of proposed modifications, (i) a corresponding action required to achieve the given proposed modification and (ii) one or more of the reference points specifying one or more locations of the referenced document at which the corresponding action is required to be performed to achieve the given proposed modification;
submitting the input to the one or more LLMs;
receiving, from the one or more LLMs, the response that includes, for each given proposed modification in the set of proposed modifications, (i) the corresponding action required to achieve the given proposed modification and (ii) the one or more of the reference points specifying one or more locations of the referenced electronic document at which the corresponding action is required to be performed to achieve the given proposed modification;
transforming content of the textual electronic document into a revised document by performing, for each given proposed modification in the set of proposed modifications, the corresponding action, required to achieve the proposed modification, at the one or more locations specified by the one or more reference points; and
outputting the revised document to a client device.

14. The non-transitory computer readable medium of claim 7, wherein the instructions cause the one or more data processing apparatus to perform operations further comprising receiving, from the client device, a request specifying one or more changes to be made to the textual electronic document, wherein creating the input describing a set of proposed modifications to the textual electronic document by the one or more LLMs comprises generating the input based on the changes specified by the request.

15. The non-transitory computer readable medium of claim 8, wherein creating the input comprises generating instructions that cause the one or more LLMs to specify, as the corresponding action for a given proposed modification, one of an insert operation, delete operation, or rewrite operation required to achieve the given proposed modification.

16. The non-transitory computer readable medium of claim 9, wherein the instructions configure the one or more data processing apparatus to perform operations further comprising:
receiving, as input from the client device, an interaction definition specifying (i) an interaction name of the interaction, (ii) an interaction description of the interaction, (iii) prompt segments, (iv) a schema, and (v) a configuration, wherein:
the interaction defines a set of tasks the one or more LLMs are being requested to perform;
the interaction name uniquely identifies the interaction from other interactions;
the interaction description provides a description of the interaction;
the prompt segments provide a list of prompt templates that are rendered as part of the prompt;
the schema specifies a structured format for the response;
the configuration specifies, for each of the one or more LLMs, an environment that connects to an inference provider of the LLM, a model to execute the interaction, and execution parameters.

17. The non-transitory computer readable medium of claim 7, wherein the textual electronic document has a token size that exceeds a maximum output window of the one or more LLMs that prevents the one or more LLMs from creating the revised document resulting from performing, for each given proposed modification in the set of proposed modifications, the corresponding action at the one or more locations specified by the one or more of the reference points.

18. The non-transitory computer readable medium of claim 7, wherein inserting the reference points comprises inserting line numbers into the content of the textual electronic document, wherein transforming the referenced document into a revised document comprises transforming the referenced document into a revised document by performing, for each given proposed modification in the set of proposed modifications, the corresponding action at the one or more locations specified by the one or more of the line numbers.
